(19) United States
(12) Patent Application Publication
(10) Pub. No.: US 2018/0176420 A1
(43) Pub. Date: Jun. 21, 2018

(54) AUTOMATIC WHITE BALANCE BASED ON SURFACE REFLECTION DECOMPOSITION AND CHROMATIC ADAPTATION

(71) Applicant: MediaTek Inc., Hsinchu (TW)

(72) Inventors: Ying-Yi Li, Taipei (TW); Hsien-Che Lee, Pleasanton, CA (US)

(21) Appl. No.: 15/675,221

(22) Filed: Aug. 11, 2017

Related U.S. Application Data
(63) Continuation-in-part of application No. 15/425,113, filed on Feb. 6, 2017.
(60) Provisional application No. 62/436,487, filed on Dec. 20, 2016.

(51) Int. Cl. H04N 1/60; G06T 5/00; G06T 1/20; G06T 5/10

(52) U.S. Cl. CPC H04N 1/6005; G06T 5/009; G06T 2207/20068; G06T 5/10; G06T 2207/10024; G06T 1/20

(57) ABSTRACT

An automatic white balance (AWB) method is performed on an image to adjust color gains of the image. The illuminant of the image is determined among a set of candidate illuminants, where each candidate illuminant is described by a corresponding coordinate pair (p, q) in a chromaticity coordinate system. The illuminant of the image can be determined by calculating an indicator value for each candidate illuminant; determining a threshold for indicator values of the candidate illuminants; identifying a subset of the candidate illuminants that have the indicator values not greater than the threshold; and for all candidate illuminants in the subset, calculating a weighted average of corresponding coordinate pairs to obtain an averaged coordinate pair. Chromatic adaptation of the illuminant in the PQ domain can also be performed on the image.

### CROSS-REFERENCE TO RELATED APPLICATIONS

This application is a continuation-in-part of U.S. patent application Ser. No. 15/425,113 filed on Feb. 6, 2017, and claims the benefit of U.S. Provisional Application No. 62/436,487 filed on Dec. 20, 2016, the entirety of which is incorporated by reference herein.

### TECHNICAL FIELD

Embodiments of the invention relate to the fields of color photography, digital cameras, color printing, and digital color image processing.

### BACKGROUND

All consumer color display devices are calibrated so that when the values of color channels Red (R)=Green (G)=Blue (B), the color is displayed at a standard “white point” chromaticity, mostly D65 or D50 according to the International Commission on Illumination (abbreviated as CIE) standard. Digital color cameras using complementary metal-oxide semiconductor (CMOS) or charge-coupled device (CCD) sensors have different sensitivities for RGB channels, resulting in raw images with some color cast (e.g., greenish). Furthermore, the color of an object varies as a function of the color of the light source (e.g., tungsten light or daylight), and the mutual reflection from ambient objects. Therefore, it is often necessary to adjust the “white point” of a raw image before one can process and display the image in proper color reproduction. This white point adjustment is called white balance (WB), and it is typically performed by applying proper gains to the color channels so that neutral objects (such as black, gray, and white) in the image are rendered with approximately equal R, G, B values. In digital cameras, the white point can be manually or automatically adjusted. Automatic white balance (AWB) is thus an important operation in color imaging applications.

Most conventional AWB algorithms rely on some physical features (such as the color gamut) and statistical properties (such as the average color distribution) of natural scenes. The conventional AWB algorithms, which are sensitive to the statistics of the scene contents, often encounter one or more of the following difficulties: 1) a dominant color biases the results, 2) the estimate has a high probability to be wrong when there is no neutral color in the image, 3) inaccurate camera calibration can cause the scene statistics to be different from the statistics used by the camera, 4) a large set of training samples with ground truth may be required to build up reliable statistics, and 5) the algorithm performance may be affected by unit-to-unit variations in the mass production of cameras. Therefore, it is highly desirable to develop AWB techniques that are more robust and relatively insensitive to scene contents.

### SUMMARY

In one embodiment, a method is provided for determining an illuminant of an image. The method comprises: calculating an indicator value for each of a set of candidate illuminants of the image, wherein each candidate illuminant is described by a corresponding coordinate pair (p, q) in a chromaticity coordinate system; determining a threshold for indicator values of the candidate illuminants; identifying a subset of the candidate illuminants that have the indicator values not greater than the threshold; and for all candidate illuminants in the subset, calculating a weighted average of corresponding coordinate pairs to obtain an averaged coordinate pair to describe the illuminant of the image in the chromaticity coordinate system.

In another embodiment, a method is provided for chromatic adaptation of an image based on adaptation requirements for a set of luminance levels. The method comprises: calculating an illuminant of the image, wherein the illuminant is described by a coordinate pair (p, q) in a chromaticity coordinate system; identifying a luminance level of the image; adjusting the coordinate pair (p, q) of the illuminant using, at least in part, one or more adaptation degrees derived from the adaptation requirements and the luminance level of the image to obtain an adapted illuminant; and adapting colors of the image to the adapted illuminant.

In yet another embodiment, a device is provided for determining an illuminant of an image. The device comprises: a memory to store the image; and an image processing pipeline coupled to the memory. The image processing pipeline is operative to: calculate an indicator value for each of a set of candidate illuminants of the image, wherein each candidate illuminant is described by a corresponding coordinate pair (p, q) in a chromaticity coordinate system; determine a threshold for indicator values of the candidate illuminants; identify a subset of the candidate illuminants that have the indicator values not greater than the threshold; and for all candidate illuminants in the subset, calculate a weighted average of corresponding coordinate pairs to obtain an averaged coordinate pair to describe the illuminant of the image in the chromaticity coordinate system.

In yet another embodiment, a device is provided for chromatic adaptation of an image based on adaptation requirements for a set of luminance levels. The device comprises: a memory to store the image; and an image processing pipeline coupled to the memory. The image processing pipeline is operative to: calculate an illuminant of the image, wherein the illuminant is described by a coordinate pair (p, q) in a chromaticity coordinate system; identify a luminance level of the image; adjust the coordinate pair (p, q) of the illuminant using, at least in part, one or more adaptation degrees derived from the adaptation requirements and the luminance level of the image to obtain an adapted illuminant; and adapt colors of the image to the adapted illuminant.

The embodiments of the invention improve the results of AWB calculations. Additionally, chromatic adaptation can be performed efficiently according to a given specification. Advantages of the embodiments will be explained in detail in the following descriptions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1A illustrates an image processing pipeline for color correction according to one embodiment.

FIG. 1B illustrates a device that includes the image processing pipeline of FIG. 1A according to one embodiment.

FIG. 2 illustrates the projection of two color surfaces on a plane that is perpendicular to a light source vector.

FIG. 3 is a diagram illustrating an automatic white balance module that performs a minimum projected area (MPA) method according to one embodiment.

FIGS. 4A, 4B and 4C illustrate examples of projection results using three different candidate illuminants.

FIG. 5 is a diagram illustrating an automatic white balance module that performs a block MPA method according to one embodiment.

FIG. 6 is a flow diagram illustrating a MPA method according to one embodiment.

FIG. 7 is a block diagram illustrating an automatic white balance module that performs a minimum total variation (MTV) method according to one embodiment.

FIG. 8 is a flow diagram illustrating a MTV method according to one embodiment.

FIG. 9 is a flow diagram illustrating a method for automatic white balance according to one embodiment.

FIG. 10 is a diagram illustrating an example in which indicator values stay below a threshold for a range of G/R ratios according to one embodiment.

FIG. 11A illustrates an averaging calculator in an MPA calculator according to one embodiment.

FIG. 11B illustrates an averaging calculator in an MTV calculator according to one embodiment.

FIG. 12 is a flow diagram illustrating a method for determining an illuminant of an image according to one embodiment.

FIG. 13 illustrates an example of adaptation requirements derived from a customer's specification according to one embodiment.

FIG. 14A is a diagram illustrating a chromatic adaptation module coupled to the output of an MPA calculator according to one embodiment.

FIG. 14B is a diagram illustrating a chromatic adaptation module coupled to the output of an MTV calculator according to one embodiment.

FIG. 15 is a flow diagram illustrating a method for chromatic adaptation of an image according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Systems and methods based on surface reflection decomposition are provided for performing automatic white balance (AWB). The systems and methods are robust and relatively insensitive to scene contents when compared with those based on conventional AWB algorithms. The systems and methods do not rely on detailed scene statistics or a large image database for training. In the following, a minimum projected area (MPA) method and a minimum total variation (MTV) method are described, both based on decomposing the surface reflection into a specular component and a diffuse component, and on the cancellation of the specular component.

As used herein, the term “tricolor values,” or equivalently “RGB values” or “RGB channels,” refers to the three color values (red, green, blue) of a color image. The terms “illuminant” and “light source” are used interchangeably. Furthermore, a chroma image refers to a color difference image, which can be computed from taking the difference between one color channel and another color channel, or the difference between linear combinations of color channels.

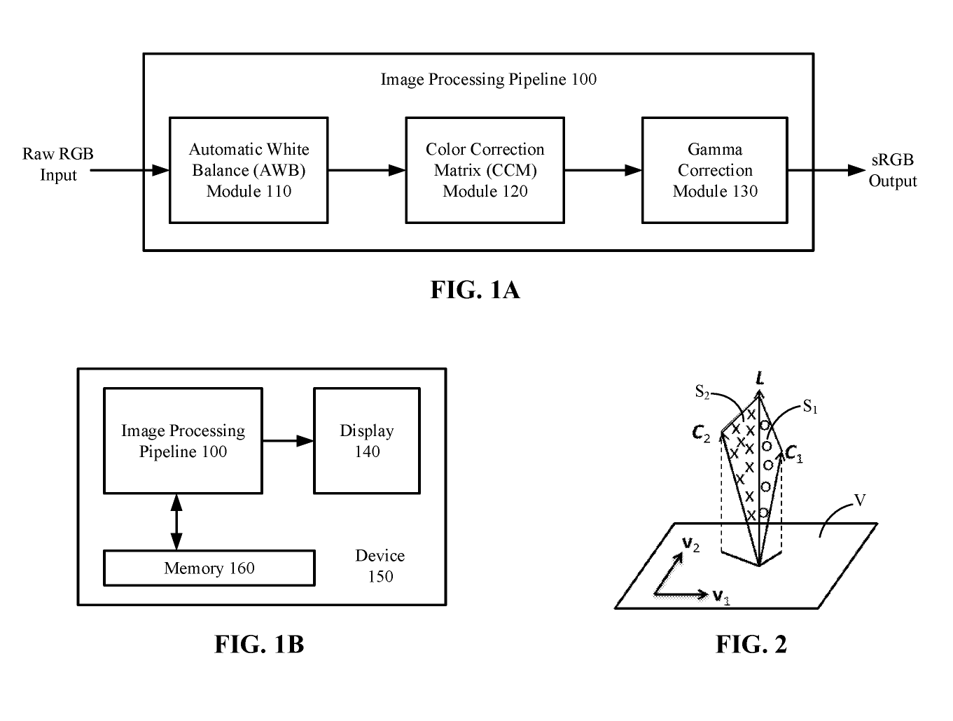

FIG. 1A illustrates an example of an image processing pipeline 100 that performs color correction according to one embodiment. The image processing pipeline 100 includes an AWB module 110, which receives raw RGB values as input, and outputs white-balance corrected RGB values. The raw RGB values may be generated by an image sensor, a camera, a video recorder, etc. The operations of the AWB module 110 will be explained in detail with reference to FIGS. 2-10. The image processing pipeline 100 further includes a color correction matrix (CCM) module 120, which performs 3×3 matrix operations on the RGB values output from the AWB module 110. The CCM module 120 can reduce the difference between the spectral characteristics of the image sensor and the spectral response of a standardized color device” (e.g., an sRGB color display). The image processing pipeline 100 may further include a gamma correction module 130, which applies a nonlinear function on the RGB values output from the CCM module 120 to compensate the nonlinear luminance effect of display devices. The output of the image processing pipeline 100 is a collection of standard RGB (sRGB) values ready to be displayed. In one embodiment, the image processing pipeline 100 includes a plurality of processing elements (e.g., Arithmetic and Logic Units (ALUs)), general-purpose processors, special-purpose circuitry, or any combination of the above, for performing the function of the AWB module 110, the CCM module 120 and the gamma correction module 130.

FIG. 1B illustrates a system in the form of a device 150 that includes the image processing pipeline 100 of FIG. 1A according to one embodiment. In addition to the image processing pipeline 100, the device 150 includes a memory 160 for storing image data or intermediate image data to be processed by the image processing pipeline 100, and a display 140 for displaying an image with sRGB values. It is understood that the device 150 may include additional components, including but not limited to: image sensors, one or more processors, user interface, network interface, etc. In one embodiment, the device 150 may be a digital camera; alternatively, the device 150 may be part of a computing and/or communication device, such as a computer, laptop, smartphone, smart watch, etc.

Before describing the embodiments of the AWB module 110, it is helpful to first explain the principles according to which the AWB module 110 operates.

Let f(θ; λ) be the bidirectional spectral reflectance distribution function (BSRDF), where θ represents all angle-dependent factors and λ the wavelength of light. The BSRDF of most colored object surfaces can be described as a combination of two reflection components, an interface reflection (specular) component and a body reflection (diffuse) component. The interface reflection is often non-selective, i.e., it reflects light of all visible wavelength equally well. This model is called the neutral interface reflection (NIR) model. Based on the NIR model, the BSRDF f(θ; λ) can be expressed as:

f(θ;λ)=ρ(λ)h(θ)+ρₛk(θ), (1)

where ρ(λ) is the diffuse reflectance factor, ρₛ is the specular reflectance factor, and h(θ) and k(θ) are the angular dependence of the reflectance factors. A key feature of the NIR model is that the spectral factor and the geometrical factor in each reflection component are completely separable.

Assume that L(λ) is the spectral power distribution of the illuminant, and Sᵣ(λ), S_{g}(λ), and S_{b}(λ) are the three sensor fundamentals (i.e., spectral responsivity functions). The RGB color space can be derived as:

R=∫L(λ)f(θ;λ)Sᵣ(λ)dλ

=h(θ)∫L(λ)ρ(λ)Sᵣ(λ)dλ+ρₛk(θ)∫L(λ)Sᵣ(λ)dλ,

G=h(θ)∫L(λ)ρ(λ)S_{g}(λ)dλ+ρₛk(θ)∫L(λ)S_{g}(λ)dλ,

B=h(θ)∫L(λ)ρ(λ)S_{b}(λ)dλ+ρₛk(θ)∫L(λ)S_{b}(λ)dλ. (2)

### Let

$${L}_{r} = \int L ( λ ) {S}_{r} ( λ ) d λ , {L}_{g} = \int L ( λ ) {S}_{g} ( λ ) d λ , {L}_{b} = \int L ( λ ) {S}_{b} ( λ ) d λ , \\ {ρ}_{r} = \frac{\int L ( λ ) ρ ( λ ) {S}_{r} ( λ ) d λ}{\int L ( λ ) {S}_{r} ( λ ) d λ} , {ρ}_{g} = \frac{\int L ( λ ) ρ ( λ ) {S}_{g} ( λ ) d λ}{\int L ( λ ) {S}_{g} ( λ ) d λ} , \\ {ρ}_{b} = \frac{\int L ( λ ) ρ ( λ ) {S}_{b} ( λ ) d λ}{\int L ( λ ) {S}_{b} ( λ ) d λ} .$$

### Then,

R=Lᵣ[ρᵣh(θ)+ρₛk(θ)],

G=L_{g}[ρ_{g}h(θ)+ρₛk(θ)],

B=L_{b}[ρ_{b}h(θ)+ρₛk(θ)], (3)

where Lᵣ, L_{g}, and L_{b} are the tristimulus values of the light source. The RGB color space can be re-written in matrix form as:

$$[ \begin{matrix}R \\ G \\ B\end{matrix} ] = h ( θ ) [ \begin{matrix}{L}_{r} & 0 & 0 \\ 0 & {L}_{g} & 0 \\ 0 & 0 & {L}_{b}\end{matrix} ] [ \begin{matrix}{ρ}_{r} \\ {ρ}_{g} \\ {ρ}_{b}\end{matrix} ] + {ρ}_{s} k ( θ ) [ \begin{matrix}{L}_{r} \\ {L}_{g} \\ {L}_{b}\end{matrix} ] . \qquad ( 4 )$$

Let v₁ and v₂ be two independent vectors in the RGB space. If the RGB values are projected on plane V spanned by v₁ and v₂, the projected coordinates will be:

$${[ \begin{matrix}{v}_{1} & {v}_{2}\end{matrix} ]}^{T} [ \begin{matrix}R \\ G \\ B\end{matrix} ] = {h ( θ ) [ \begin{matrix}{v}_{1} & {v}_{2}\end{matrix} ]}^{T} [ \begin{matrix}{L}_{r} & 0 & 0 \\ 0 & {L}_{g} & 0 \\ 0 & 0 & {L}_{b}\end{matrix} ] [ \begin{matrix}{ρ}_{r} \\ {ρ}_{g} \\ {ρ}_{b}\end{matrix} ] + {ρ}_{s} {k ( θ ) [ \begin{matrix}{v}_{1} & {v}_{2}\end{matrix} ]}^{T} [ \begin{matrix}{L}_{r} \\ {L}_{g} \\ {L}_{b}\end{matrix} ] . \qquad ( 5 )$$

Let L=[Lᵣ L_{g} L_{b}]^{T} be the light source vector. The second term in equation (5) disappears when [v₁ v₂]^{T}L=0. It means that when plane V is perpendicular to the light source vector L, the specular component is canceled.

FIG. 2 illustrates an example of projecting the colors of two surfaces on the plane V. According to the NIR model, every color vector of light reflected from a given surface (e.g., S₁) is a linear combination of the specular component (represented by the light source vector L) and the diffuse component (represented by C₁). All the colors of S₁ are on the same plane as L and C₁. Similarly, all the colors of another surface (e.g., S₂) are on the same plane as L and C₂. Therefore, all the colors under the same light source are on the planes that share a common vector L. If all the colors are projected along the light source vector L, their projections will form several lines and those lines intersect at one point which is the projected point of the light source vector. If the projection direction is not along the light source vector L (i.e., if V is not perpendicular to L), then the specular component is not canceled. In this case, the projected colors will no longer form lines on plane V, but instead will spread out over two-dimensional area of plane V. This two-dimensional area, referred to as the projected area on Plane V, can be calculated when v₁ and v₂ are orthonormal. Plane V varies when v₁ and v₂ change. By changing v₁ and v₂, the projected area will become the smallest when plane V is perpendicular to the light source vector L. It does not matter which specific v₁ and v₂ are used as the basis vectors, as all of them produce substantially the same results.

In the AWB calculations, the light source vector L for the ground truth light source is unknown. The MPA method varies plane V by choosing different candidate illuminants. From the chosen light source vector L=(Lᵣ, L_{g}, L_{b}) of the candidate illuminant, the orthonormal basis vectors v₁ and v₂ can be computed, and a given image's projected area on the plane spanned by v₁ and v₂ can also be computed. The projected area is the smallest when the chosen light source vector L is the closest to the ground truth light source of the image.

In one embodiment, the orthonormal basis vectors may be parameterized as follows:

$$\begin{matrix}{v}_{1} ( α , β ) = {\frac{1}{\sqrt{{α}^{2} + 1}} [ \begin{matrix}α & - 1 & 0\end{matrix} ]}^{T} , & ( 6 ) \\ {v}_{2} ( α , β ) = {\frac{1}{\sqrt{{α}^{2} + {α}^{4} + {{β}^{2} ( {α}^{2} + 1 )}^{2}}} [ \begin{matrix}- α & - {α}^{2} & β ( {α}^{2} + 1 )\end{matrix} ]}^{T} . & ( 7 )\end{matrix}$$

When α=L_{g}/Lᵣ and β=L_{g}/L_{b}, plane V(α, β) is perpendicular to L.

In one embodiment, the search range for the light sources is narrowed to a subspace where light sources are more likely to occur, since searching through all possible planes V(α, β) is very time consuming. Narrowing the search range also has the benefit of reducing the possibility of finding the wrong light source. In one embodiment, the search range can be a set of illuminants commonly occurred in consumer images of the intended application domain. The term “consumer images” refers to color images that are typically seen on image display devices used by content consumers. Alternatively or additionally, a suitable blending of the daylight locus and the blackbody radiator locus may be used. This blending can provide a light locus covering most illuminants in the consumer images. To search for the light source of an image, the MPA method calculates the image's projected area for each candidate illuminant in a set of candidate illuminants along the light locus. The candidate illuminant that produces the minimum projected area is the best estimate of the scene illuminant (i.e., the ground truth light source), and the image is white balanced according to that scene illuminant. In one embodiment, the MPA method minimizes the following expression:

$$arg {min}_{α , β} w ( α , β ) Area ( α , β ) , \qquad ( 8 )$$

where w(α, β) is a bias function, and Area(α, β) is the projected area on plane V(α, β), which is spanned by v₁(α, β) and v₂(α, β). The bias function may be used to modify a projected area and thus improve the performance of the MPA method. The bias function relies on the gross scene illuminant distribution, but not the scene content. Therefore, the same bias function can work for any camera model after the camera is calibrated. Details of the bias function w(α, β) will be provided later. In alternative embodiments, the bias function may be omitted (i.e., set to one).

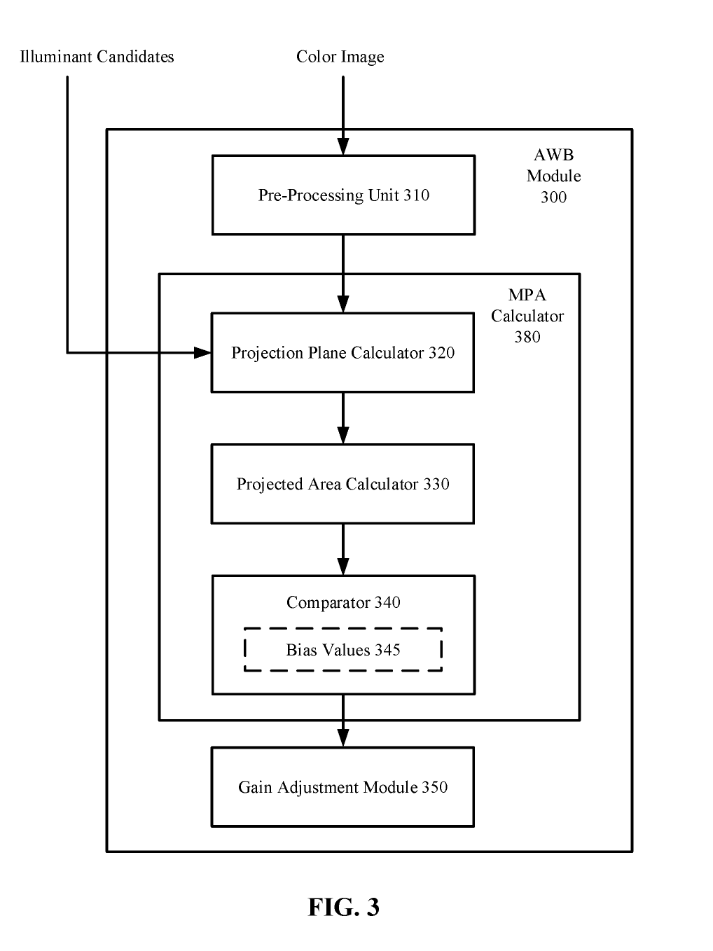

FIG. 3 illustrates an AWB module 300 for performing the MPA method according to one embodiment. The AWB module 300 is an example of the AWB module 110 of FIG. 1A. The AWB module 300 includes a pre-processing unit 310, which processes raw RGB data of an input image to remove over-exposed, under-exposed and saturated pixels. The removal of these pixels can speed up AWB computation and reduce noise. In one embodiment, a pixel is deemed over-exposed and removed if one or more of its R value, G value and B value is within a predetermined vicinity from the maximum of that pixel's color data range; in other words, when one or more of the pixel's color channels is greater than a threshold. After these pixels are removed, the pre-processing unit 310 may group-average the input image by dividing the image into multiple groups of neighboring pixels, and calculating a weighted average of the tricolor values of the neighboring pixels in each group. The weight for each group may be one or another number. In one embodiment, after the calculating the group average, the pre-processing unit 310 may remove under-exposed pixels from the image. A pixel is over-exposed if the sum of its R value, G value and B value is above a first threshold; a pixel is under-exposed if the sum of its R value, G value and B value is below a second threshold. The pre-processing unit 310 may also remove saturated pixels from the image. A pixel is saturated if one of its R value, G value and B value is below a predetermined threshold.

In one embodiment, after the pixel removal and group averaging operations, the pre-processing unit 310 may sub-sample the image to produce a pre-processed image. The pre-processed image is fed into an MPA calculator 380 in the AWB module 300 for MPA calculations.

In one embodiment, the MPA calculator 380 includes a projection plane calculator 320 and a projected area calculator 330. The projection plane calculator 320 calculates two orthonormal vectors v₁ and v₂ that span a plane perpendicular to a light source vector (Lᵣ, L_{g}, L_{b}) of a candidate illuminant. In one embodiment, the projection plane calculator 320 calculates v₁ and v₂ according to equations (6) and (7), where α and β are given or calculated from a candidate illuminant.

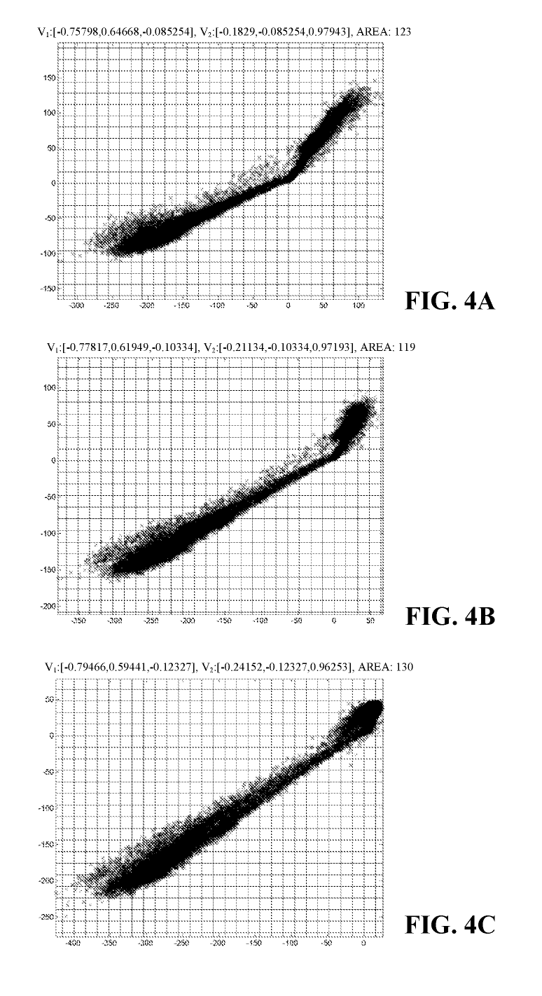

After the projection plane is determined, the projected area calculator 330 projects the RGB values of each pixel in the pre-processed image to that projection plane. The result of the projection is a collection of points that fall onto the projection plane. If each color is represented as an ideal point, then the result of the projection will produce a set of scattered dots on the projected plane, as shown in the examples of FIGS. 4A, 4B and 4C, each of which illustrates a projection result using a different candidate illuminant. The local dot density becomes higher when the projection is along the ground truth light source vector. However, computing dot density requires a large amount of computations. In one embodiment, the projection plane is divided into a set of spatial bins (e.g., squares). A square is counted when one or more pixels are projected into that square. The total number of counted squares may be used as an estimate of the projected area.

Referring to FIGS. 4A, 4B and 4C, in each example, the ‘x’ marks represent the projection points of all pixels of the image. When the candidate illuminant is closer to the ground truth, the total projected area marked by ‘x’s becomes smaller. Each example uses a different candidate illuminant described by the orthonormal bases v₁ and v₂. The candidate illuminant that produces the minimum projected area of 119 in FIG. 4B has the smallest area, and is therefore the closest to the ground truth among the three candidate illuminants.

Referring again to FIG. 3, after the projected area calculator 330 calculates the projected areas for a set of different candidate illuminants, a comparator 340 compares the projected areas and identifies a candidate illuminant that produces the minimum projected area. In one embodiment, as an option to improve the AWB results, the comparator 340 may multiply each projected area with the aforementioned bias function, shown herein as a bias value 345 (i.e., a weight), before the comparison. The bias values 345 may be determined based on prior knowledge about how frequently an illuminant along the light locus may occur in consumer images. That is, the bias values 345 represent the prior knowledge of scene illuminant distribution, and are not related to scene contents. In one embodiment, each candidate illuminant is associated with a bias value, which may be denoted as a function w(α, β), where a and are color ratios of the candidate illuminant. The bias values are stable from one camera model to another camera model.

After the comparator 340 identifies a candidate illuminant that produces the minimum projected area, a gain adjustment unit 350 adjusts the color gain of the input image according to the color ratios α and β of the candidate illuminant.

For an image with multiple different colored objects, the projected area is often minimized when the projection is along the light source vector. However, for images of a single dominant color, the minimum projected area can occur when either the specular component or the diffuse component of the dominant color is canceled. In order to better handle such images of few colors, the search is constrained to the minimum projected area caused by the cancellation of the specular component, not by the diffuse component of the dominant color. One way is to search for the candidates which are close to where the potential light sources are located in the chromaticity space. Therefore, the minimum projected area is searched along the light locus which goes through the population of the known light sources.

In one embodiment, a chromaticity coordinate system (p, q) may be used to parameterize the distribution of light locus in the chromaticity domain with reduced distortion. The coordinate system (p, q) is defined as:

$$p = \frac{1}{\sqrt{2}} r - \frac{1}{\sqrt{2}} b , \\ q = - \frac{1}{\sqrt{6}} r + \frac{2}{\sqrt{6}} g - \frac{1}{\sqrt{6}} b , \qquad ( 9 )$$

where r=R/(R+G+B), g=G/(R+G+B), and b=B/(R+G+B).

For a candidate illuminant (Lᵣ, L_{g}, L_{b}), its (p, q) coordinates can be determined by replacing R, G, B values in equations (9) with the Lᵣ, L_{g}, L_{b} values.

A light locus may be obtained by fitting the color data taken by a reference camera under different illuminants. For example, a curve fitting from three types of light sources: shade, daylight, and tungsten can provide a very good light locus. In one embodiment, a given light locus may be represented by a second-order polynomial function in the (p, q) domain having the form of:

q=a₁p²+a₂p+a₃. (10)

Given (p, q), the following equations calculate (r, g, b):

$$r = \frac{1}{\sqrt{2 }} p - \frac{1}{\sqrt{6} } q + \frac{1}{3} , \\ g = \frac{\sqrt{6}}{3} q + \frac{1}{3} , \\ b = - \frac{1}{\sqrt{2}} p - \frac{1}{\sqrt{6}} q + \frac{1}{3} . \qquad ( 11 )$$

The color ratios α and β can be obtained by:

$$α = \frac{g}{r} , β = \frac{g}{b} . \qquad ( 12 )$$

Accordingly, given a (p, q) along the light locus, the color ratios α and β can be computed. Using equations (6) and (7), the orthonormal vectors v₁(α, β) and v₂(α, β) can be computed, and the projected area of an image on plane V spanned by v₁(α, β) and v₂(α, β) can also be computed.

When a scene is illuminated by a single dominant light source, the MPA method can estimate the light source accurately. However, some scenes have more than one light source. In one embodiment, a block MPA method is used to handle such multiple-illuminant scenarios. With the block MPA method, an image is divided into several blocks and the MPA method is applied to each block.

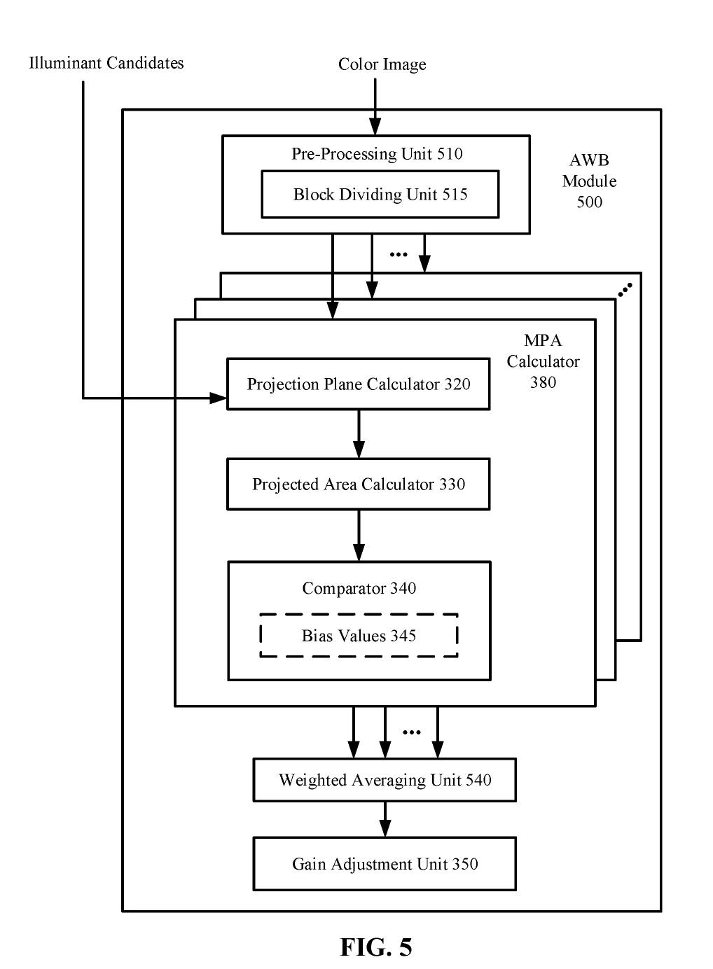

FIG. 5 illustrates an AWB module 500 for performing the block MPA method according to one embodiment. The AWB module 500 is an example of the AWB module 110 of FIG. 1A. The AWB module 500 includes a pre-processing unit 510, which further includes a block dividing unit 515 to divide an input image into multiple blocks. The pre-processing unit 510 performs the same pixel removal operations as the pre-processing unit 310 of FIG. 3 on each block to remove over-exposed, under-exposed and saturated pixels. The pre-processing unit 510 also determines whether each block has a sufficient number of pixels (e.g., 10 pixels) for the MPA method after the pixel removal operations. If less than a threshold number of blocks (e.g., half of the number of blocks) have sufficient number of pixels for the MPA method, the pre-processing unit 510 re-divides the image into fewer number of blocks, such that the number of new blocks in the image is greater than the threshold number.

In one embodiment, the AWB module 500 includes one or more MPA calculators 310 to execute the MPA method on each block. The per-block results are gathered by an weighted averaging unit 540, which averages the chromaticity coordinate p first, then finds the other chromaticity coordinate q based on the fitted curve (e.g., the second-order polynomial function in (10)) for a given light locus. In one embodiment, the weighted averaging unit 540 applies a weight to each block; for example, the weight of a block having the main object may be higher than other blocks. In alternative embodiment, the weighted averaging unit 540 may apply the same weight to all blocks. The output of the weighted averaging unit 540 is a resulting candidate illuminant or a representation thereof. The gain adjustment unit 350 then adjusts the color gain of the input image using the color ratios α and β of the resulting candidate illuminant.

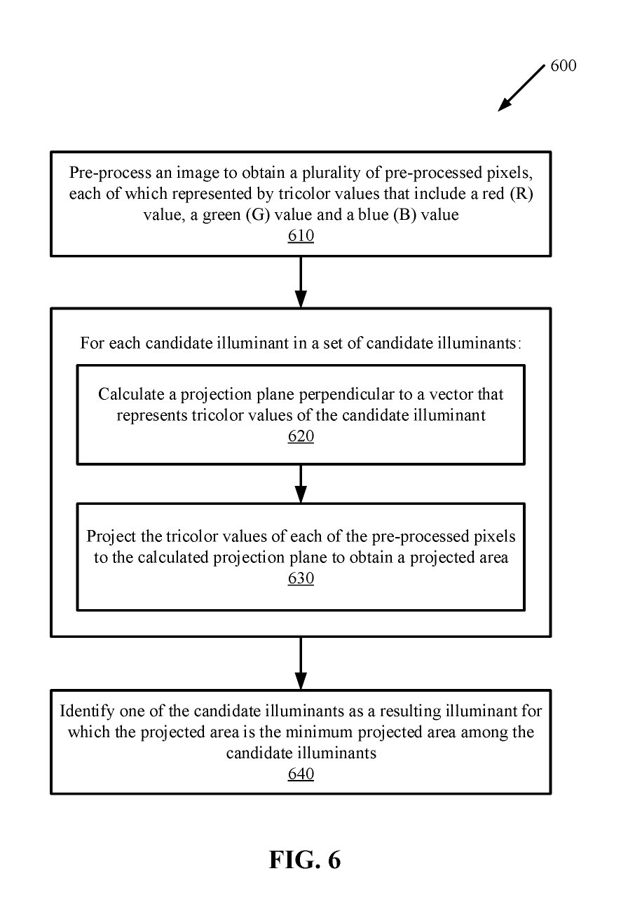

FIG. 6 is a flow diagram illustrating a MPA method 600 performed on a color image according to one embodiment. The MPA method 600 may be performed by a device, such as the device 150 of FIG. 1B; more specifically, the MPA method 600 may be performed by the AWB module 110 of FIG. 1A, the AWB module 300 of FIG. 3 and/or the AWB module 500 of FIG. 5.

The MPA method 600 begins with a device pre-processing an image to obtain pre-processed pixels, each of which represented by tricolor values that include a red (R) value, a green (G) value and a blue (B) value (step 610). For each candidate illuminant in a set of candidate illuminants, the device performs the following operations: calculating a projection plane perpendicular to a vector that represents tricolor values of the candidate illuminant (step 620), and projecting the tricolor values of each of the pre-processed pixels to the calculated projection plane to obtain a projected area (step 630). One of the candidate illuminants is identified as a resulting illuminant for which the projected area is the minimum projected area among the candidate illuminants (step 640). The device may use the color ratios of the resulting illuminant to adjust the color gains of the image.

According to another embodiment, AWB may be performed using the MTV method, which is also based on the same principle as the MPA method by seeking to cancel the specular component. According to the NIR model, a pair of chroma images, (αC₁−C₂) and (βC₃−C₂), can be created from a given image by scaling one color channel and taking the difference with another color channel. (C₁, C₂, C₃) is the linear transformation of tricolor values (R,G,B).

$$[ \begin{matrix}{C}_{1} \\ {C}_{2} \\ {C}_{2}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] \qquad ( 13 )$$

Both (αC₁−C₂) and (βC₃−C₂) are functions of spatial locations in the image. The two chroma images can be expressed as:

(αC₁−C₂)=[(αa₁₁−a₂₁)Lᵣρᵣ+(αa₁₂−a₂₂)L_{g}ρ_{g}+(αa₁₃−a₂₃)L_{b}ρ_{b}]h(θ)+[(αa₁₁−a₂₁)Lᵣ+(αa₁₂−a₂₂)L_{g}+(αa₁₃−a₂₃)L_{b}]ρₛk(θ),

(βC₃−C₂)=[(βa₃₁−a₂₁)Lᵣρᵣ+(βa₃₂−a₂₂)L_{g}ρ_{g}+(βa₃₃−a₂₃)L_{b}ρ_{b}]h(θ)+[(βa₃₁−a₂₁)Lᵣ+(βa₃₂−a₂₂)L_{g}+(βa₃₃−a₂₃)L_{b}]ρₛk(θ). (14)

When α=(a₂₁Lᵣ+a₂₂L_{g}+a₂₃L_{b})/(a₁₁Lᵣ+a₁₂L_{g}+a₁₃L_{b}) and β=(a₂₁Lᵣ+a₂₂L_{g}+a₂₃L_{b})/(a₃₁Lᵣ+a₃₂L_{g}+a₃₃L_{b}):

(αC₁−C₂)=[(αa₁₁−a₂₁)Lᵣρᵣ+(αa₁₂−a₂₂)L_{g}ρ_{g}+(αa₁₃−a₂₃)L_{b}ρ_{b}]h(θ),

(βC₃−C₂)=[(βa₃₁−a₂₁)Lᵣρᵣ+(βa₃₂−a₂₂)L_{g}ρ_{g}+(βa₃₃−a₂₃)L_{b}ρ_{b}]h(θ). (15)

The specular component is canceled for both αC₁−C₂ and βC₃−C₂. When the cancellation happens, the total variation of αC₁−C₂ and βC₃−C₂ is greatly reduced because the modulation due to the specular components is gone. There is left only a signal modulation entirely due to the difference in the diffuse components.

By searching along a given light locus, the MTV method finds a candidate illuminant, represented by color ratios α and β, that minimizes the following expression of total variation. The color ratios α and β may be computed from a given point (p, q) on a given light locus using equations (11) and (12). The total variation in this embodiment can be expressed as a sum of absolute gradient magnitudes of the two chroma images in (14):

$$arg {min}_{α , β} {\sum }_{n} \vert ∇ ( α {C}_{1} ( n ) - {C}_{2} ( n ) ) \vert + \vert ∇ ( β {C}_{3} ( n ) - {C}_{2} ( n ) ) \vert . \qquad ( 16 )$$

It is noted that the gradient of a two-dimensional image is a vector that has an x-component and a y-component. For computational efficiency, a simplified one-dimensional approximation of total variation can be used:

$$arg {min}_{α , β} {\sum }_{n} \vert α [ {C}_{1} ( n ) - {C}_{1} ( n + 1 ) ] - [ {C}_{2} ( n ) - {C}_{2} ( n + 1 ) ] \vert + \vert β [ {C}_{3} ( n ) - {C}_{3} ( n + 1 ) ] - [ {C}_{2} ( n ) - {C}_{2} ( n + 1 ) ] \vert \qquad ( 17 )$$

In one embodiment, if any neighboring pixel has been removed due to over-exposure, under-exposure, or color saturation, the gradient of that pixel is excluded from the total variation calculation.

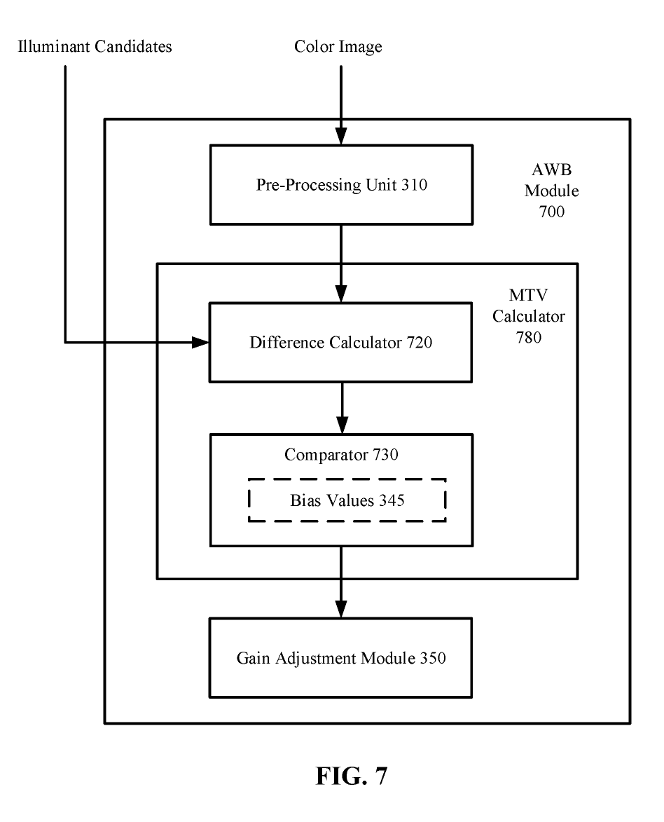

FIG. 7 illustrates an AWB module 700 for performing the MTV method according to one embodiment. The AWB module 700 is another example of the AWB module 110 of FIG. 1A. The AWB module 700 includes the pre-processing unit 310, which processes raw RGB data of an input image to remove over-exposed, under-exposed and saturated pixels. The AWB module 700 further includes an MTV calculator 780, which searches for a minimum total variation solution in a set of candidate illuminants. More specifically, the MTV calculator 780 further includes a difference calculator 720 and a comparator 730. The difference calculator 720 calculates the total variation for each candidate illuminant, and the comparator 730 compares the results from the difference calculator 720 to identify a minimum total variation. In one embodiment, the comparator 730 may multiply each total variation with a bias value 345 (i.e., a weight) before the comparison. The bias values 345 may be determined based on prior knowledge about how frequently an illuminant along the light locus may occur in consumer images. That is, the bias values 345 represent the prior knowledge of scene illuminant distribution, and are not related to scene contents. In one embodiment, each candidate illuminant is associated with a bias value, which may be denoted as a function w(α, β), where α and β are color ratios of the candidate illuminant. The bias values are stable from one camera model to another camera model.

After the comparator 730 identifies the candidate illuminant that produces the minimum total variation, the gain adjustment unit 350 adjusts the color gain of the input image using the color ratios α and β of the candidate illuminant. Experiment results show that the MTV method performs well for a single dominant illuminant as well as multiple illuminants.

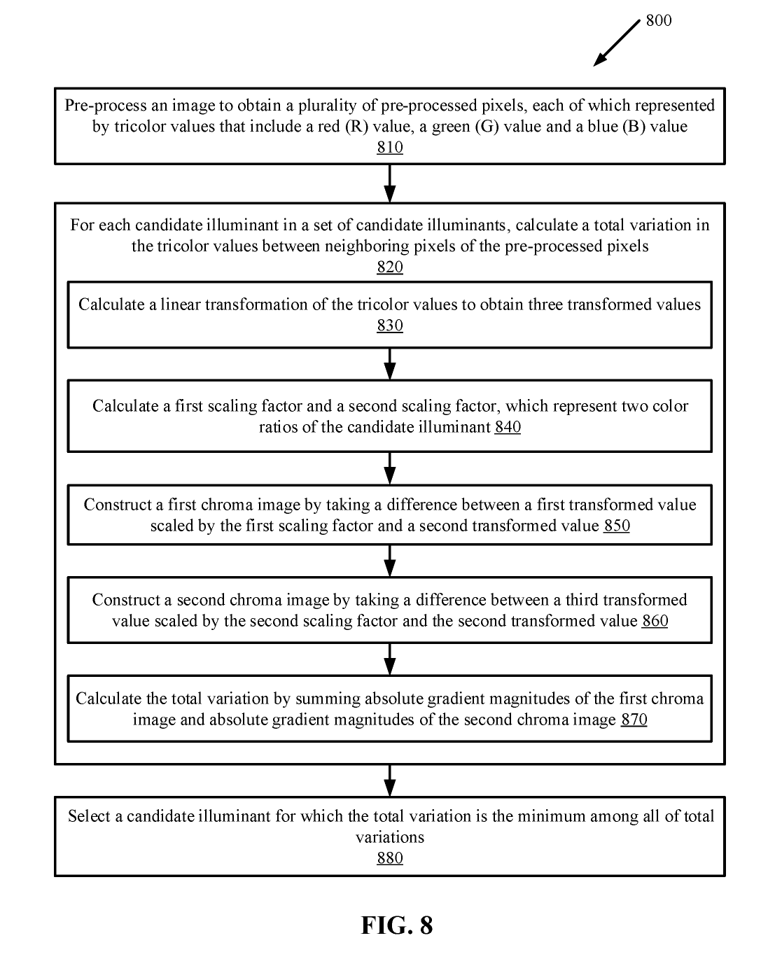

FIG. 8 is a flow diagram illustrating a MTV method 800 performed on a color image according to an alternative embodiment. In this alternative embodiment, a linear transformation is applied to the tricolor values in the calculation of the total variation. The MTV method 800 may be performed by a device, such as the device 150 of FIG. 1B; more specifically, the MTV method 800 may be performed by the AWB module 110 of FIG. 1A and/or the AWB module 700 of FIG. 7.

The MTV method 800 begins with a device pre-processing an image to obtain a plurality of pre-processed pixels, each of which represented by tricolor values that include a red (R) value, a green (G) value and a blue (B) value (step 810). For each candidate illuminant in a set of candidate illuminants, the device calculates a total variation in the tricolor values between neighboring pixels of the pre-processed pixels (step 820). The calculation of the total variation includes the operations of: calculating a linear transformation of the tricolor values to obtain three transformed values (step 830); calculating a first scaling factor and a second scaling factor, which represent two color ratios of the candidate illuminant (step 840); constructing a first chroma image by taking a difference between a first transformed value scaled by the first scaling factor and a second transformed value (step 850); constructing a second chroma image by taking a difference between a third transformed value scaled by the second scaling factor and the second transformed value (step 860); and calculating an indicator value by summing absolute gradient magnitudes of the first chroma image and absolute gradient magnitudes of the second chroma image (step 870). After the total variations of all candidate illuminants are computed, the device selects a candidate illuminant for which the total variation is the minimum among all of total variations (step 880).

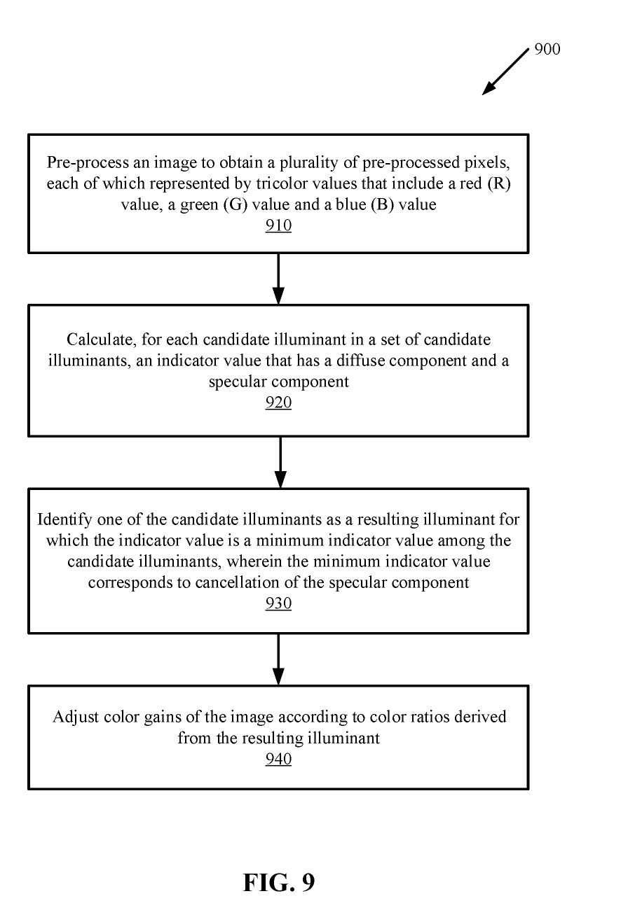

FIG. 9 is a flow diagram illustrating a method 900 for performing automatic white balance on an image according to one embodiment. The method 900 may be performed by a device, such as the device 150 of FIG. 1B; more specifically, the method 900 may be performed by the AWB module 110 of FIG. 1A, the AWB module 300 of FIG. 3, the AWB module 500 of FIG. 5, and/or the AWB module 700 of FIG. 7.

The method 900 begins with a device pre-processing the image to obtain a plurality of pre-processed pixels, each of which represented by tricolor values that include a red (R) value, a green (G) value and a blue (B) value (step 910). For each candidate illuminant in a set of candidate illuminants, the device calculates an indicator value that has a diffuse component and a specular component (step 920). The device then identifies one of the candidate illuminants as a resulting illuminant for which the indicator value is a minimum indicator value among the candidate illuminants, wherein the minimum indicator value corresponds to cancellation of the specular component (step 930). According to color ratios derived from the resulting illuminant, the device adjusts color gains of the image (step 940). In one embodiment, the indicator value is a projected area as described in connection with the MPA method 600 in FIG. 6; in alternative embodiments, the indicator value is a total variation as described in connection with the MTV method 800 in FIG. 8.

In the following description, an improvement to the MPA and MTV methods will be presented. The improvement is aiming at bringing the calculated illuminant of an image closer to the ground truth, such as when multiple candidate illuminants produce similar values in projected areas (or total variations); that is, their differences in value may be within a margin of error. Thus, instead of taking one of these candidate illuminants as the illuminant of the image, the coordinate values of these candidate illuminants in the PQ domain may be averaged to generate an averaged illuminant. An example scenario in which this approach may be useful is when a large number of pixels in an image are located on, or within a threshold distance from, the light locus from which the candidate illuminants are obtained. In such cases, the minimum projected area calculated by the MPA method and the minimum total variation calculated by the MTV method may be unstable, and the averaged illuminant may be closer to the ground truth than the candidate illuminant that produces the minimum projected area (or total variation) in the calculations. In the description herein, the term “average” is used interchangeably with “weighted average” where the weight may be 1 or another numeric value; e.g., a probability value derived from a priori knowledge about the candidate illuminants. For example, the probability value of a first candidate illuminant may be higher than that of a second candidate illuminant if the first candidate illuminant occurs more often in the consumer image population than the second candidate illuminant.

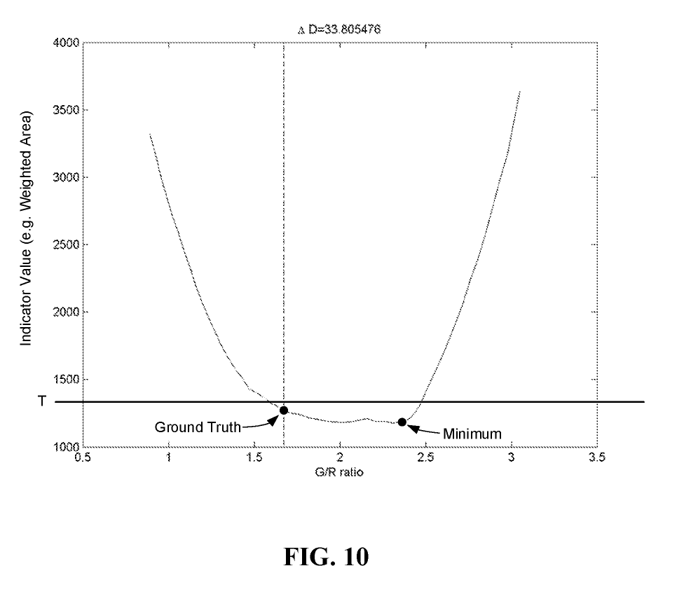

To simplify the description, the term “indicator value” in the following is used to refer to any of the “projected area” in the MPA method, the “total variation” in the MTV method, and their respective weighted values. FIG. 10 illustrates an example result of applying the MPA method to an image, in which indicator values (e.g., weighted areas) stay substantially the same for a range of G/R ratios, where each G/R ratio represents a candidate illuminant. In this example, the ground truth corresponds to an indicator value that is not the minimum indicator value, but both the ground truth indicator value and the minimum indicator value are below a threshold (T). In one embodiment, all of the indicator values less than, or not greater than, the threshold (T) are accepted for calculating an averaged illuminant, and the averaged illuminant may be calculated by averaging the p and q coordinate values of their corresponding candidate illuminants. The averaged illuminant may be used as the illuminant of the image.

In one embodiment, the threshold (T) may be a value between the maximum and the minimum of the indicator values such as T=V_min+Δ, where V_min is the minimum indicator value among all indicator values produced by the candidate illuminants, and Δ is less than the difference between the maximum and the minimum of the indicator values. In some scenarios Δ may be greater than zero, such as when the minimum indicator value is produced by a candidate illuminant that is not a boundary candidate illuminant. It is noted that the term “boundary” herein refers to a p-coordinate boundary, as using a q-coordinate boundary for the purpose of calculating the threshold (T) may cause significant errors in the result of calculating the averaged illuminant.

In some scenarios Δ may be zero, such as when one of the boundary candidate illuminants produces the minimum indicator value, and/or when the difference between the minimum and the second smallest indicator value is greater than a tolerance. A boundary candidate illuminant is described by a coordinate pair (p, q), where the p-coordinate value is at the boundary of an interval or space that encompasses all candidate illuminants in the chromaticity coordinate system. For example, if all of the candidate illuminants lie on a one-dimensional curve in the (p, q) space parameterized by a range of p-coordinate values, the candidate illuminants having the smallest and largest p-coordinate values on the light locus are the boundary candidate illuminants. If all of the candidate illuminants lie in a two-dimensional chromaticity space described by a range of p-coordinate values and a range of q-coordinate values, the candidate illuminants having the smallest and largest p-coordinate values are the boundary candidate illuminants.

Thus, a general form of the threshold T may be: T=min[(V_min+k(V_max−V_min)), V_boundary], where k is a value between zero and one (e.g., k=0.125), V_min is the minimum indicator value, V_max is the maximum indicator value, and V_boundary represents the boundary indicator values produced by the boundary candidate illuminants as defined above.

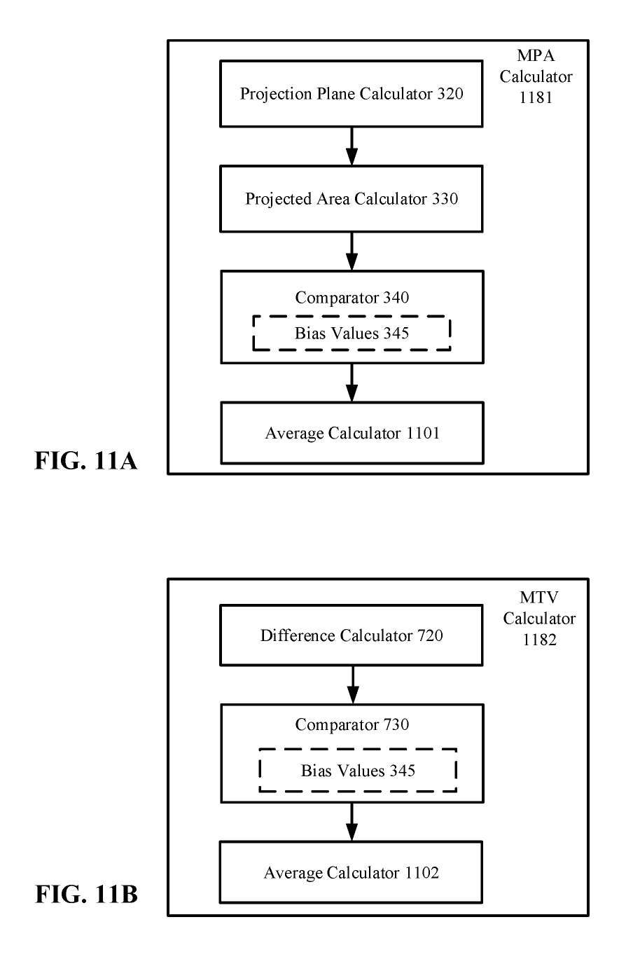

FIG. 11A illustrates an example of an MPA calculator 1181 according to one embodiment. The MPA calculator 1181 is an alternative example of the MPA calculator 380 of FIG. 3 and FIG. 5. As mentioned before, the projection plane calculator 320 and the projected area calculator 330 calculate a projected area for each candidate illuminant. The comparator 340 compares the projected areas or weighted projected areas, determines a threshold (T), and identifies those candidate illuminants whose projected areas or weighted projected areas are not greater than T. The MPA calculator 1181 also includes an average calculator 1101 for calculating the average of the identified candidate illuminants. Each of these candidate illuminants is described by a corresponding coordinate pair (p, q) in the chromaticity coordinate system. The average calculator 1101 averages these corresponding p-coordinate values and the corresponding q-coordinate values to determine an averaged p-coordinate value (p_{avg}) and an averaged q-coordinate value (q_{avg}), respectively. The resulting averaged illuminant, which is identified or described by the averaged coordinate pair (p_{avg}, q_{avg}) in the chromaticity coordinate system, may be used as the illuminant of the image for subsequent image processing, such as for AWB processing.

Similarly, FIG. 11B illustrates an example of an MTV calculator 1182 according to one embodiment. The MTV calculator 1182 is an alternative example of the MTV calculator 780 of FIG. 7. As mentioned before, the difference calculator 720 calculates the total variation for each candidate illuminant. The comparator 730 compares the total variations or weighted total variations, determines a threshold (T), and identifies those candidate illuminants whose total variations or weighted total variations are not greater than T. The MTV calculator 1182 also includes an average calculator 1102 for calculating the average of the identified candidate illuminants. Each of these candidate illuminants is described by a corresponding coordinate pair (p, q) in the chromaticity coordinate system. The average calculator 1101 averages the corresponding p-coordinate values and the corresponding q-coordinate values to determine an averaged p-coordinate value (p_{avg}) and an averaged q-coordinate value (q_{avg}), respectively. The illuminant of the image is identified or described by the averaged coordinate pair (p_{avg}, q_{avg}) in the chromaticity coordinate system.

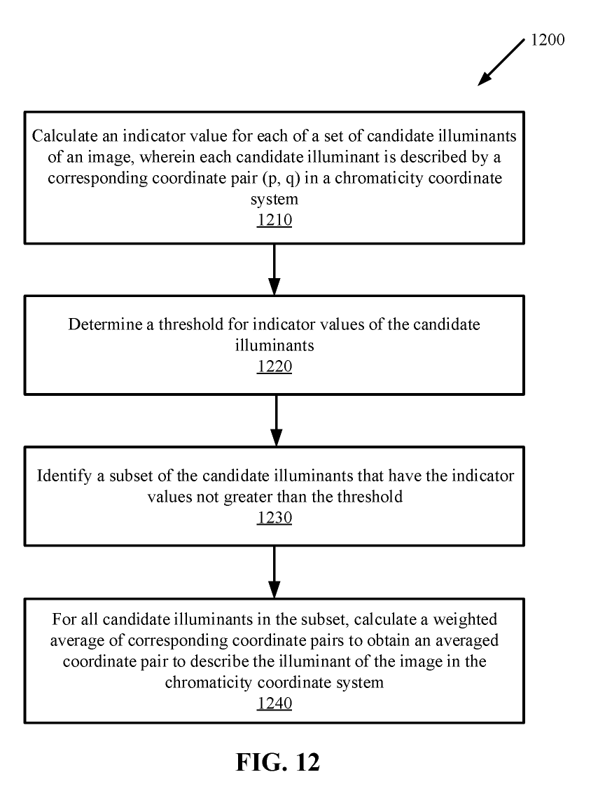

FIG. 12 is a flow diagram illustrating a method 1200 for determining an illuminant of an image according to one embodiment. The method 1200 may be performed by a device, such as the device 150 of FIG. 1B; more specifically, the method 1200 may be performed by the MPA calculator 1181 of FIG. 11A or the MTV calculator 1182 of FIG. 11B.

The method 1200 begins at step 1210 when a device calculates an indicator value for each candidate illuminant in a set of candidate illuminants of the image. Each candidate illuminant is described by a corresponding coordinate pair (p, q) in a chromaticity coordinate system. The device at step 1220 determines a threshold for indicator values of the candidate illuminants; and at step 1230 identifies a subset of the candidate illuminants that have the indicator values not greater than the threshold. For all candidate illuminants in the subset, the device at step 1240 averages corresponding coordinate pairs to obtain a weighted average coordinate pair that describes the illuminant of the image in the chromaticity coordinate system. More specifically, the device may average the corresponding p-coordinate values and the corresponding q-coordinate values to determine an averaged p-coordinate value (p_{avg}) and an averaged q-coordinate value (q_{avg}), respectively. The weighted average coordinate pair (p_{avg}, q_{avg}) identifies the illuminant of the image in the chromaticity coordinate system.

In some embodiments, the illuminant of the image as calculated above may be adjusted according to customer's requirements or specification. A customer may request that images be reproduced by an imaging device (e.g., a camera) such that the white point of the resulting image is adjusted to suit the customer's color preference. In one embodiment, the chromatic adaption is performed in the chromaticity coordinate system; that is, the PQ domain. Chromatic adaptation in the PQ domain involves much less complex calculations than in the LMS color space, also known as the human photoreceptor response color space (where “L” stands for long-wavelength-sensitive, “M” stands for middle-wavelength-sensitive, and “S” stands for short-wavelength-sensitive, cone responses). The chromatic adaptation in the LMS color space typically requires multiple 3×3 matrix conversions.

A customer may specify the target RGB colors. For example, a customer may provide a number of raw (original) images with a gray card, and the corresponding target images with the gray card. The gray card may be any percentage gray or any color(s) suitable for serving as a reference point. From the images provided by the customer, the values of (p_{origin}, q_{origin}) in the raw images and (p_{adapt}, q_{adapt}) in the target images can be calculated for the given luminance levels in these images, where (p_{origin}, q_{origin}) are the p-coordinate value and the q-coordinate value of the illuminant before chromatic adaptation, respectively; and (p_{adapt}, q_{adapt}) are the p-coordinate value and the q-coordinate value of the illuminant after chromatic adaptation, respectively.

Based on (p_{origin}, q_{origin}) and (p_{adapt}, q_{adapt}) derived from the customer's specification, the following model expressed as equations (18) can be used to determine the adaptation degrees Aₚ and A_{q}.

p_{adapt}=(1−Aₚ)p_{D}_{₆₅}+Aₚ·p_{origin}, and q_{adapt}=(1−A_{q})q_{D}_{₆₅}+A_{q}·q_{origin} (18)

where p_{D65} and q_{D65} are the p-coordinate value and the q-coordinate value of a standard illuminant D65, respectively. In alternative embodiments, the p-coordinate value and the q-coordinate value of a different default illuminant, such as D50, Illuminant E, or any other preferred illuminant, may be used instead of p_{D65} and q_{D65}. In one embodiment, the adaptation degree Aₚ required by and derived from the customer's specification may include multiple ranges of Aₚ values, with each range corresponding to a luminance level. The same may apply to the adaptation degree A_{q}.

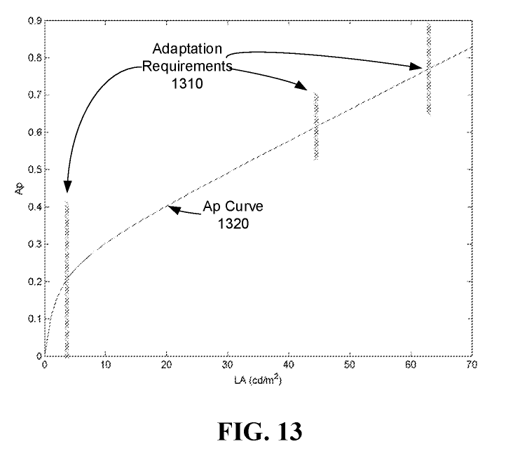

FIG. 13 illustrates an example of adaptation requirements 1310 expressed in a graph according to one embodiment. The horizontal axis of the graph is the luminance level (L_{A}) and the vertical axis is the adaptation degree Aₚ for the p-coordinate. The luminance level (L_{A}) of an input image may be calculated from the exposure time, the focal length, the aperture size, and the signal gain of the camera when the image is taken. In this example, the graph specifies the adaptation requirements 1310 by three vertical stacks of x marks, with each stack indicating a range of Aₚ values for a corresponding luminance level. The ranges of Aₚ values may be generated from the customer-provided images as described above in connection with equations (18). Although the adaptation requirements 1310 in this example specifies the Aₚ ranges for three corresponding luminance levels, it is understood that alternative adaptation requirements may specify the Aₚ ranges for any given number of luminance levels.

In one embodiment, a monotonically increasing Aₚ curve 1320 as a function of L_{A} is generated by curve fitting, such that the Aₚ curve 1320 passes through all three Aₚ ranges at the three given luminance levels. In this example, the Aₚ curve 1320 may be expressed in the form of:

$${A}_{p} = {L}_{A} ( \frac{{x}_{1}}{{x}_{2} + {L}_{A} } + {x}_{3} ) . \qquad ( 19 )$$

The parameters x₁, x₂ and x₃ may be generated by known curve fitting methods. Similarly, the customer's requirements may include another graph specifying adaptation requirements for the adaptation degree A_{q} for the q-coordinates as a function of L_{A}. Similarly, curve fitting may be performed on the requirements to obtain an A_{q} curve. For example, the A_{q} curve may be expressed in the form of:

$${A}_{q} = {L}_{A} ( \frac{{x}_{4}}{{x}_{5} + {L}_{A}} + {x}_{6} ) . \qquad ( 20 )$$

The parameters x₄, x₅ and x₆ may be generated by known curve fitting methods. In alternative embodiments, the equations (19) and (20) may include different number of parameters.

As described above, an illuminant in the chromaticity coordinate system can be described by a coordinate pair (p, q), and this illuminant can be adjusted according to the luminance level (L_{A}) of the image and the adaptation degree (Aₚ) or adaptation degrees (Aₚ and A_{q}) for that luminance level. With the adaptation curve 1320, an adapted illuminant (p_{adapt}, q_{adapt}) can be found for any luminance level in the graph from the given (p_{origin}, q_{origin}) using equations (18).

In one embodiment, the equations (18) may be used to find the adapted illuminant (p_{adapt}, q_{adapt}) for p_{origin}≤T₁ or p_{origin}≥T₂, where T₁ and T₂ mark the boundary points beyond which the image colors need adjustment. For T₁<p_{origin}<T₂, Aₚ=A_{q}=1; hence p_{adapt}=p_{origin} and q_{adapt}=q_{origin}.

In another embodiment, the model of (18) may be simplified based on the observation that q_{adapt} is typically not sensitive to A_{q}. Thus, the following model expressed as equations (21) may be used to find the adapted illuminant (p_{adapt}, q_{adapt}) for p_{origin}≤T₁ or p_{origin}≥T₂.

p_{adapt}=(1−Aₚ)p_{D}_{₆₅}+Aₚ·p_{origin} and q_{adapt}=a₁p_{adapt}²+a₂p_{adapt}²+a₃+q_{offset} (21)

where q_{offset} is the distance between q_{origin} and the light locus, and a₁, a₂ and a₃ are the coefficients of the light locus (see equation (10)). As mentioned above in connection with equations (18), the p-coordinate value and the q-coordinate value of a different default illuminant, such as D50, Illuminant E, or any other preferred illuminant, may be used instead of p_{D65} and q_{D65}. For T₁<p_{origin}<T₂, Aₚ=A_{q}=1; hence p_{adapt}=p_{origin} and q_{adapt}=q_{origin}.

In some scenarios, the customer's specification may be converted into the PQ domain that includes multiple regions of curve fitting, and a different monotonically increasing Aₚ curve may be generated for each region. For example, the customer's specification when converted into the PQ domain may specify an Aₚ range of [0, 0.1] for L_{A}=10, an Aₚ range of [0.5, 0.6] for L_{A}=11, an Aₚ range of [0.3, 0.4] for L_{A}=40. In this case, a single monotonically increasing curve cannot fit into all the required ranges. Thus, multiple regions may be used where each region includes the Aₚ ranges or data points for which a single monotonically increasing curve can fit.

For example, the boundaries of the regions may be defined by p_{origin}, such as Region 1: p_{origin}<T₁; Region 2: T₁≤p_{origin}<T₂; . . . ; Region n: Tₙ₋₁≤p_{origin}<Tₙ; Region (n+1): p_{origin}≥Tₙ.

The chromatic adaptation model for each Region i may be expressed as:

p_{adapt}=(1−Aₚ_{ᵢ})p_{D}_{₆₅}+Aₚ_{ᵢ}·p_{origin}, and q_{adapt}=a₁p_{adapt}²+a₂p_{adapt}+a₃+q_{offset} (22)

where

$${A}_{{p}_{i}} = {L}_{A} ( \frac{{x}_{i 1}}{{x}_{i 2} + {L}_{A} } + {x}_{i 3} ) ,$$

and where xᵢ₁, xᵢ₂, and xᵢ₃ are found by curve fitting based on a customer's specification. As mentioned above in connection with equations (18) and (21), the p-coordinate value and the q-coordinate value of a different default illuminant, such as D50, Illuminant E, or any other preferred illuminant, may be used instead of p_{D65} and q_{D65}. The transition between regions is continuous so that a slight shift does not cause visible color change due to different adaptation.

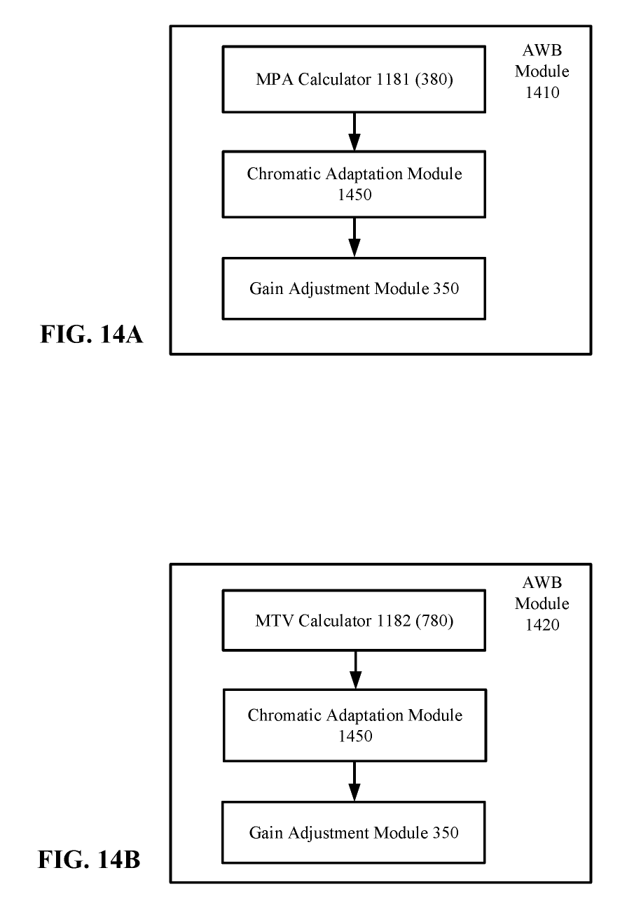

FIG. 14A illustrates an AWB module 1410 according to an embodiment. The AWB module 1410 includes the MPA calculator 1181 of FIG. 11A (or the MPA calculator 380 of FIG. 3) coupled to a chromatic adaptation module 1450, which is further coupled to the gain adjustment module 350 described above in connection with FIGS. 3, 5 and 7 for adjusting the color gain of an input image. Although one MPA calculator is shown, in some embodiments the AWB module 1410 may include multiple MPA calculators 380 or 1181, each calculating an illuminant (or averaged illuminant) for a block of the input image, as described above in connection with FIG. 5. The chromatic adaptation module 1450 calculates p_{adapt} and q_{adapt} for adjusting the (p, q) values of the illuminant.

FIG. 14B illustrates an AWB module 1420 according to an embodiment. The AWB module 1420 includes the MTV calculator 1182 of FIG. 11B (or the MTV calculator 780 of FIG. 7) coupled to a chromatic adaptation module 1450, which is further coupled to the gain adjustment module 350. The chromatic adaptation module 1450 calculates p_{adapt} and q_{adapt} for adjusting the (p, q) values of the illuminant.

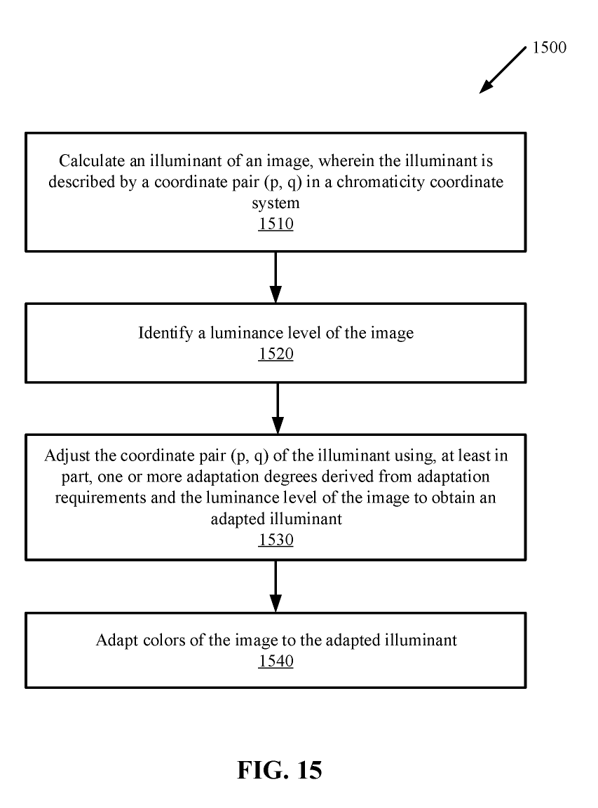

FIG. 15 is a flow diagram illustrating a method 1500 for chromatic adaptation of an image based on adaptation requirements for a set of luminance levels according to one embodiment. The method 1500 may be performed by a device, such as the device 150 of FIG. 1B; more specifically, the method 1500 may be performed by the AWB module 1410 of FIG. 14A or the AWB module 1420 of FIG. 14B.

The method 1500 begins at step 1510 when a device calculates an illuminant of the image, wherein the illuminant is described by a coordinate pair (p, q) in a chromaticity coordinate system. The device at step 1520 identifies a luminance level of the image; and at step 1530 adjusts the coordinate pair (p, q) of the illuminant using, at least in part, an adaptation degree derived from the adaptation requirements and the luminance level of the image to obtain an adapted illuminant. The device at step 1540 adapts the colors of the image to the adapted illuminant.

The operations of the flow diagrams of FIGS. 6, 8, 9, 12 and 15 have been described with reference to the exemplary embodiments of FIGS. 1A, 1B, 3, 5, 7, 11A, 11B, 14A and 14B. However, it should be understood that the operations of the flow diagrams can be performed by embodiments of the invention other than the embodiments discussed with reference to FIGS. 1A, 1B, 3, 5, 7, 11A, 11B, 14A and 14B, and the embodiments discussed with reference to FIGS. 1A, 1B, 3, 5, 7, 11A, 11B, 14A and 14B can perform operations different than those discussed with reference to the flow diagrams. While the flow diagrams show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for determining an illuminant of an image, comprising:
calculating an indicator value for each of a set of candidate illuminants of the image, wherein each candidate illuminant is described by a corresponding coordinate pair (p, q) in a chromaticity coordinate system;
determining a threshold for indicator values of the candidate illuminants;
identifying a subset of the candidate illuminants that have the indicator values not greater than the threshold; and
for all candidate illuminants in the subset, calculating a weighted average of corresponding coordinate pairs to obtain an averaged coordinate pair to describe the illuminant of the image in the chromaticity coordinate system.

2. The method of claim 1, wherein calculating the weighted average of the corresponding coordinate pairs further comprises:
averaging corresponding p-coordinate values and corresponding q-coordinate values to determine an averaged p-coordinate value (p_{avg}) and an averaged q-coordinate value (q_{avg}), respectively, wherein the averaged coordinate pair (p_{avg}, q_{avg}) describes the illuminant of the image in the chromaticity coordinate system.

3. The method of claim 1, wherein the indicator value is a projected area produced by projecting the image onto a projection plane perpendicular to a vector representing tricolor values of a candidate illuminant.

4. The method of claim 1, wherein the indicator value is a total variation in tricolor values between neighboring pixels, wherein calculating the total variation further comprises:
calculating a linear transformation of the tricolor values to obtain three transformed values;
calculating a first scaling degree and a second scaling degree, which represent two color ratios of the candidate illuminant;
constructing a first chroma image by taking a difference between a first transformed value scaled by the first scaling degree and a second transformed value;
constructing a second chroma image by taking a difference between a third transformed value scaled by the second scaling degree and the second transformed value; and
calculating the total variation by summing absolute gradient magnitudes of the first chroma image and absolute gradient magnitudes of the second chroma image.

5. The method of claim 1, wherein the threshold is set to be higher than a minimum of the indicator values when the minimum is produced by a candidate illuminant which is not one of boundary candidate illuminants, wherein each boundary candidate illuminant has a p-coordinate value at the boundary of an interval or space that encompasses all candidate illuminants of the image in the chromaticity coordinate system.

6. The method of claim 1, wherein the threshold is set to be a minimum of the indicator values when the minimum is produced by one of boundary candidate illuminants, wherein each boundary candidate illuminant has a p-coordinate value at the boundary of an interval or space that encompasses all candidate illuminants of the image in the chromaticity coordinate system.

7. A method for chromatic adaptation of an image based on adaptation requirements for a set of luminance levels, comprising:
calculating an illuminant of the image, wherein the illuminant is described by a coordinate pair (p, q) in a chromaticity coordinate system;
identifying a luminance level of the image;
adjusting the coordinate pair (p, q) of the illuminant using, at least in part, one or more adaptation degrees derived from the adaptation requirements and the luminance level of the image to obtain an adapted illuminant; and
adapting colors of the image to the adapted illuminant.

8. The method of claim 7, wherein adjusting the coordinate pair further comprises:
scaling a p-coordinate value of the illuminant by an adaptation degree for the luminance level; and
adding the scaled p-coordinate value to a p-coordinate value of a default illuminant scaled by one minus the adaptation degree to obtain an adapted p-coordinate value of the adapted illuminant.

9. The method of claim 8, further comprising:
calculating an adapted q-coordinate value of the adapted illuminant by evaluating a function of the adapted p-coordinate value.

10. The method of claim 7, further comprising:
scaling a q-coordinate value of the illuminant by an adaptation degree for the luminance level; and
adding the scaled q-coordinate value to a q-coordinate value of the default illuminant scaled by one minus the adaptation degree to obtain an adapted q-coordinate value of the adapted illuminant.

11. The method of claim 7, further comprising:
calculating different adaptation curves for different regions of p-coordinate values based on the adaptation requirements; and
after calculating the illuminant of the image, identifying one of the regions and one of the adaptation curves according to the p-coordinate value of the illuminant for calculating the adapted illuminant.

12. A device for determining an illuminant of an image, comprising
a memory to store the image; and
an image processing pipeline coupled to the memory, the image processing pipeline operative to:
calculate an indicator value for each of a set of candidate illuminants of the image, wherein each candidate illuminant is described by a corresponding coordinate pair (p, q) in a chromaticity coordinate system;
determine a threshold for indicator values of the candidate illuminants;
identify a subset of the candidate illuminants that have the indicator values not greater than the threshold; and
for all candidate illuminants in the subset, calculate a weighted average of corresponding coordinate pairs to obtain an averaged coordinate pair to describe the illuminant of the image in the chromaticity coordinate system.

13. The device of claim 12, wherein the image processing pipeline when calculating the weighted average of the corresponding coordinate pairs is further operative to:
average corresponding p-coordinate values and corresponding q-coordinate values to determine an averaged p-coordinate value (p_{avg}) and an averaged q-coordinate value (q_{avg}), respectively, wherein the averaged coordinate pair (p_{avg}, q_{avg}) describes the illuminant of the image in the chromaticity coordinate system.

14. The device of claim 12, wherein the indicator value is a projected area produced by projecting the image onto a projection plane perpendicular to a vector representing tricolor values of a candidate illuminant.

15. The device of claim 12, wherein the indicator value is a total variation in the tricolor values between neighboring pixels, wherein the image processing pipeline when calculating the total variation is further operative to:
calculate a linear transformation of the tricolor values to obtain three transformed values;
calculate a first scaling degree and a second scaling degree, which represent two color ratios of the candidate illuminant;
construct a first chroma image by taking a difference between a first transformed value scaled by the first scaling degree and a second transformed value;
construct a second chroma image by taking a difference between a third transformed value scaled by the second scaling degree and the second transformed value; and
calculate the total variation by summing absolute gradient magnitudes of the first chroma image and absolute gradient magnitudes of the second chroma image.

16. The device of claim 12, wherein the threshold is set to be higher than a minimum of the indicator values when the minimum is produced by a candidate illuminant which is not one of boundary candidate illuminants, wherein each boundary candidate illuminant has a p-coordinate value at the boundary of an interval or space that encompasses all candidate illuminants of the image in the chromaticity coordinate system.

17. The device of claim 12, wherein the threshold is set to be a minimum of the indicator values when the minimum is produced by one of boundary candidate illuminants, wherein each boundary candidate illuminant has a p-coordinate value at the boundary of an interval or space that encompasses all candidate illuminants of the image in the chromaticity coordinate system.

18. A device for chromatic adaptation of an image based on adaptation requirements for a set of luminance levels, comprising:
a memory to store the image; and
an image processing pipeline coupled to the memory, the image processing pipeline operative to:
calculate an illuminant of the image, wherein the illuminant is described by a coordinate pair (p, q) in a chromaticity coordinate system;
identify a luminance level of the image;
adjust the coordinate pair (p, q) of the illuminant using, at least in part, one or more adaptation degrees derived from the adaptation requirements and the luminance level of the image to obtain an adapted illuminant; and
adapt colors of the image to the adapted illuminant.

19. The device of claim 18, wherein the image processing pipeline when adjusting the coordinate pair is further operative to:
scale a p-coordinate value of the illuminant by an adaptation degree for the luminance level; and
add the scaled p-coordinate value to a p-coordinate value of a default illuminant scaled by one minus the adaptation degree to obtain an adapted p-coordinate value of the adapted illuminant.

20. The device of claim 19, wherein the image processing pipeline when adjusting the coordinate pair is further operative to:
calculate an adapted q-coordinate value of the adapted illuminant by evaluating a function of the adapted p-coordinate value.

21. The device of claim 18, wherein the image processing pipeline when adjusting the coordinate pair is further operative to:
scale a q-coordinate value of the illuminant by the adaptation degree for the luminance level; and
add the scaled q-coordinate value to a q-coordinate value of the default illuminant scaled by one minus the adaptation degree to obtain an adapted q-coordinate value of the adapted illuminant.

22. The device of claim 18, wherein the image processing pipeline when adjusting the coordinate pair is further operative to:
calculate different adaptation curves for different regions of p-coordinate values based on the adaptation requirements; and
after calculating the illuminant of the image, identify one of the regions and one of the adaptation curves according to the p-coordinate value of the illuminant for calculating the adapted illuminant.
